(19) United States
(12) Patent Application Publication
(10) Pub. No.: US 2012/0160282 A1
(43) Pub. Date: Jun. 28, 2012

(54) APPARATUS FOR WASHING RESIN MOLD

(76) Inventor: Toshihiro Hasegawa, Aichi (JP)

(21) Appl. No.: 13/107,091

(22) Filed: May 13, 2011

(30) Foreign Application Priority Data
Dec. 28, 2010 (JP) 2010-292355

(51) Int. Cl. B08B 3/00

(52) U.S. Cl. 134/134

(57) ABSTRACT

An apparatus for washing resin mold of this invention includes a feed port 11 through which flexible resin mold is loaded; a process tank 31 laid while horizontally aligning the longitudinal axis thereof, having one end thereof communicated with the feed port 11, having therein a housing space for housing the resin mold, and having a plurality of openings formed in the bottom surface thereof; a rotating shaft 72 disposed in the process tank 31, and rotationally driven by a drive unit 21; a plurality of rotating blades 81 to 84, 86 to 89 having the base ends thereof respectively fixed on the rotating shaft 72, and the tip ends located inside the process tank 31; a discharge path 69 formed at the other end of the process tank 31, and through which the resin mold after being washed is discharged; a washing water jetting nozzle 76 for jetting washing water to the upstream side in the process tank 31; and a sterilizing water jetting nozzle 78 for jetting sterilizing water to the downstream side in the process tank 31, relative to the position of the washing water jetting nozzle 76.

### BACKGROUND

1. Technical Field

The present invention relates to an apparatus for washing resin mold, and in particular to an apparatus for washing resin mold for removing nasty smell from flexible resin mold in a form of film, sheet or bag, previously used as wrapping material for foods, agricultural materials or the like.

2. Background Art

In the conventional process of separating an articles-to-be-treated, composed of wrapping materials (flexible resin mold) covered with organic wastes or the like, into the wrapping materials and the organic wastes, and washing off the organic wastes or the like (adherent) adhered on the wrapping materials, there has been used, for example, a device capable of separating therein the articles-to-be-treated into the wrapping materials and adherent such as organic wastes or the like previously covered the wrapping materials, washing the wrapping materials, and outputting them in a separate manner (see Japanese Laid-Open Patent Publication No. 2003-320264, referred to as Patent Document 1). The device disclosed in Patent Document 1 has a feed port through which the articles-to-be-treated are loaded; a cylindrical process tank communicated with the feed port and allowing therein separation of the articles-to-be-processed into the wrapping materials and foods (adherent); a discharge port and a discharge path, provided to the process tank, through which the adherent and the wrapping materials, after being separated, are respectively output; a drive shaft provided in the process tank and rotationally driven by a drive means; and a plurality of rotating blades having the base ends thereof respectively fixed on the drive shaft, and having the tip ends located so as to be opposed with the inner circumferential surface of the process tank. In the process tank of this device, there is provided jetting nozzles through which a treatment agent (water, oil, or water/oil mixture) is jetted into the process tank. According to the invention, by virtue of the treatment agent jetted through the jetting nozzles into the process tank, it is reportedly possible to effectively avoid a non-conformity such that the enclosed foods are undesirably kneaded in the process tank and thereby cannot be discharged, even if the foods were raw pasta such as Japanese wheat pasta (udon) or Japanese rice cake (mochi).

The wrapping materials thus separated by the device disclosed in Patent Document 1, however, had residues of foods and seasonings remained thereon, so that putrefaction of the residues have often resulted in nasty smell (offensive odor), or have damaged incinerators. One known proposal aimed at solving the problems is a device having washing brushes attached to the ends of the rotating blades (Japanese Patent No. 4183178, referred to as Patent Document 2). The device disclosed in Patent Document 2 is inspired by the invention disclosed in Patent Document 1, and is configured to fix the washing brushes so that the ends thereof are positioned close to the inner circumferential surface of the process tank, and are allowed to brought into sliding contact with the wrapping materials as the drive shaft rotates. The device disclosed in Patent Document 2 is aimed at forcedly separating the residues such as foods, seasonings or the like previously adhered on the wrapping materials, making use of washing water jetted through the jetting nozzles and the washing brushes, and thereby preventing the nasty smell.

### SUMMARY

The device disclosed in Patent Document 2 have, however, been suffering from a problem that the nasty smell could not completely be removed even after the adherent, such as residues or seasonings, was separated from the articles-to-be-treated. This is because the treatment agent jetted through the jetting nozzles is water, oil or water/oil mixture, having no sterilizing activity, so that the wrapping materials even visually judged as being clean without any recognizable adherent may still carry destructive fungus contained in the organic wastes. Accordingly, any efforts of recycling the resin, previously composing the wrapping materials output from the conventional washing apparatus, after being pelletized for the purpose of recycling them as source materials for new products, have been successful only in a limited range of products due to nasty smell possibly emitted from the new products. The efforts have alternatively resulted in large devaluation of the source resins to be recycled, due to such nasty smell.

The present invention was proposed aiming at solving the above-described problems inherent to the conventional apparatuses, an object of which is to provide a novel apparatus for washing resin mold, capable of effectively washing off adherent previously adhered on the flexible resin mold, capable of removing offensive odor or nasty odor stuck on the resin mold, and capable of successfully contributing to effective recycling of the treated resin mold as the source materials for new products.

The present invention is proposed aiming at solving the above-described problems. According to a first aspect of the present invention (the invention described in Claim 1), there is provided an apparatus for washing resin mold which includes: a feed port through which flexible resin mold is loaded; a process tank laid while horizontally aligning the longitudinal axis thereof, having one end thereof communicated with the feed port, having therein a housing space for housing the resin mold, and having a plurality of openings formed in the bottom surface thereof; a rotating shaft disposed in the process tank, and rotationally driven by a drive unit; a plurality of rotating blades having the base ends thereof respectively fixed on the rotating shaft, and the tip ends located inside the process tank; a discharge path formed at the other end of the process tank, and through which the resin mold after being washed is discharged; a washing water jetting nozzle for jetting washing water to the upstream side in the process tank; and a sterilizing water jetting nozzle for jetting sterilizing water to the downstream side in the process tank, relative to the position of the washing water jetting nozzle.

The flexible resin mold which composes the first invention includes film-like or sheet-like resin mold previously used as wrapping materials for foods or agricultural materials, bags previously used for enclosing foods or other articles, flexible containers, and crushed products of these materials. The washing water jetting nozzle and the sterilizing water jetting nozzle which compose the first invention may be good enough, if the washing water jetting nozzle is disposed at the upstream side in the process tank, and if the sterilizing water jetting nozzle is disposed at the downstream side in the process tank, without any limitation on the number of provision of the nozzles.

According to the first aspect of the present invention, since the washing water jetting nozzle for jetting washing water and the sterilizing water jetting nozzle for jetting sterilizing water are disposed at the upstream side and downstream side, respectively, in the process tank, so that the resin mold input through the feed port into the process tank may be tumbled by a plurality of rotating blades which rotate in the process tank, ruptured into irregular and undefined geometries after colliding against the rotating blades and inner surface of the process tank, and are further washed by washing water jetted through the washing water jetting nozzle. In short, any adherent previously adhered on the resin mold is washed off by the washing water. The resin mold is then beaten against the inner circumferential surface of the process tank, while being driven by rotational force and centrifugal force of the rotating blades, and gradually creeps on the inner circumferential surface of the process tank towards the downstream side, while being brought into frictional contact with the inner circumferential surface. In this process, while depending on the range of jetting of the washing water jetted through the washing water jetting nozzle and the number of washing water jetting nozzles, the resin mold may be washed repetitively in the course of creeping in the process tank towards the downstream side, if the range of jetting of the washing water is broad, or if there are a plurality of washing water jetting nozzles aligned on the downstream side. The resin mold thus washed with the washing water jetted through the washing water jetting nozzle(s) is then washed and sterilized by the sterilizing water jetted through the sterilizing water jetting nozzle. As a consequence, according to the apparatus for washing resin mold of the first aspect of the present invention, the washed resin mold may successfully be suppressed in nasty smell or offensive odor otherwise possibly ascribable to post-washing proliferation of fungus, may successfully contribute to be recycled as source materials for new products, and may successfully be prevented from being devaluated in the market price.

According to a second aspect of the present invention (the invention described in Claim 2), the sterilizing water jetted through the sterilizing water jetting nozzle described in the first invention is a weakly-acidic aqueous hypochlorous acid solution.

According to the second aspect of the present invention, since the sterilizing water jetted through the sterilizing water jetting nozzle is a weakly-acidic aqueous hypochlorous acid solution, having a stronger effect of fungus elimination as compared with general chlorine-containing disinfectants or alcohol, so that destructive fungus adhered on the wrapping materials or the like may be killed, and thereby the nasty smell may be removed in a more complete manner. Aqueous hypochlorite solution, represented by aqueous sodium hypochlorite solution, is generally used as a disinfectant for sterilizing foods or other articles to be sterilized. In most cases, the aqueous hypochlorite solution is used in a form having a relatively high hydrogen ion concentration index (referred to as “pH”, hereinafter), typically at pH8 or higher. A higher value of pH means a higher population of hypochlorite ions or free chlorine, and the solution exhibits only a relatively weak sterilizing effect. In order to allow the aqueous hypochlorite solution to express stronger sterilizing effect, it is preferable to lower the pH to thereby elevate the population of non-ionized hypochlorous acid. Too low pH (pH4 or lower, for example) may, however, result in generation of a large amount of hazardous chlorine gas, so that, in view expressing a strong sterilizing effect while suppressing generation of chlorine gas, the pH of the aqueous hypochlorite solution may preferably be adjusted to 6 or around so as to keep the solution weakly acidic.

### BRIEF DESCRIPTION OF THE DRAWINGS

FIG. 1 is a plan view schematically illustrating a washing facility equipped with an apparatus for washing resin mold according to an embodiment of the present invention;

FIG. 2 is a right side elevation of the washing facility illustrated in FIG. 1;

FIG. 3 is a front elevation of the apparatus for washing resin mold according to the embodiment of the present invention;

FIG. 4 is a sectional view of the apparatus for washing resin mold illustrated in FIG. 3;

FIG. 5 is a sectional view illustrating the apparatus shown in FIG. 3, but without the rotating blades;

FIG. 6 is a sectional view of the apparatus for washing resin mold, taken along line A-A in FIG. 4;

FIG. 7 is a sectional view of the apparatus for washing resin mold, taken along line B-B in FIG. 4; and

FIG. 8 is a sectional view of the apparatus for washing resin mold, taken along line C-C in FIG. 6.

### DETAILED DESCRIPTION

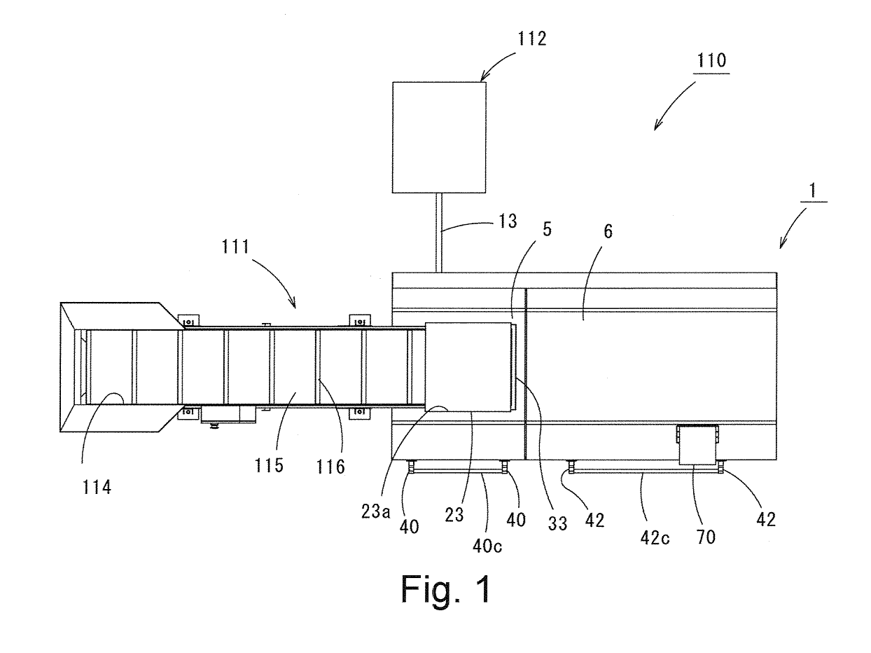

The apparatus for washing resin mold (referred to as “washing apparatus”, hereinafter) according to one embodiment of the present invention will be detailed referring to the attached drawings. A washing apparatus 1 of this embodiment is a constituent of a washing facility 110 illustrated in FIG. 1. The washing facility 110 will firstly be briefed, followed by detailed description of the washing apparatus 1. The washing facility 110 and the later-described washing apparatus 1 are adopted with the present invention, for the purpose of washing the flexible resin mold composed of vinyl chloride, polyethylene terephthalate (PET) or the like so as to remove adherents adhered thereon, and of removing nasty smell and offensive odor stuck on the resin mold. The resin mold herein is a film-like, sheet-like or bag-like product previously used as a wrapping material for foods or as an agricultural material. The resin mold to be treated by the washing apparatus 1 is also a product having organic wastes or agricultural chemicals adhered thereon, or a product with nasty smell or offensive odor ascribable to destructive fungus contained in the organic wastes or agricultural chemicals. The washing facility 110 will be explained below.

As illustrated in FIG. 1, the washing facility 110 is configured by the washing apparatus 1, a conveyor unit 111 for feeding the resin mold to a later-described hopper 23, composing the washing apparatus 1, and a weakly-acidic aqueous hypochlorous acid solution production unit 112 which produces a weakly-acidic aqueous hypochlorous acid solution (sterilizing water) described later, and pressure-feeds the weakly-acidic aqueous hypochlorous acid solution to the washing apparatus 1. The conveyor unit 111 is disposed on the left lateral side (upstream side) of the washing apparatus 1 as viewed in FIG. 1, and is configured by a feed port 114 which is disposed on the lower left, through which the resin mold is loaded, and a circulating conveyor belt 115 capable of receiving thereon the thus-loaded resin mold fed through the feed port 114. The conveyor unit 111 is installed in an inclined manner, so as to convey the resin mold thus placed on the conveyor belt 115 and to throw it through the hopper 23 into a feed frame 33, described later, of the washing apparatus 1. The conveyor belt 115 has anti-slipping ribs 116 fixed on the surface thereof at regular intervals, so as to keep the loaded resin mold unslippable, and is rotationally driven by an unillustrated drive motor so as to ascend the top surface having the resin mold loaded thereon. The resin mold loaded on the conveyor belt 115 is thus conveyed up into the flow path 23a of the hopper 23.

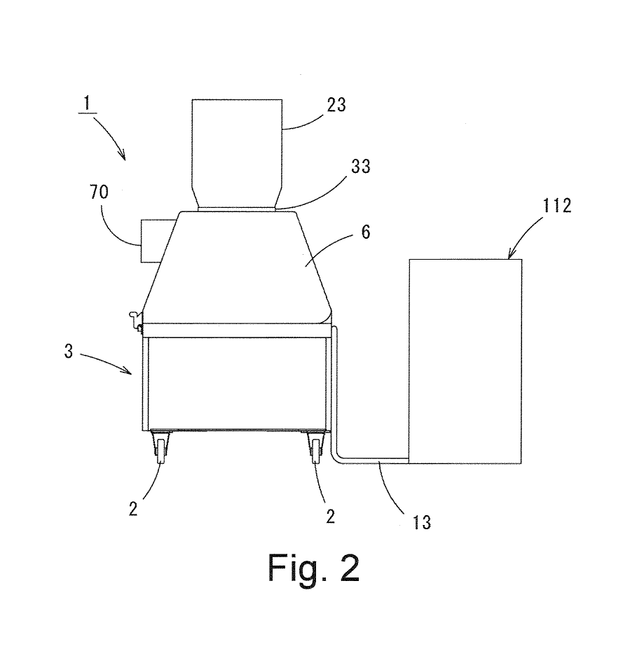

The weakly-acidic aqueous hypochlorous acid solution production unit 112 is disposed on the rear side of the washing apparatus 1, as illustrated in FIG. 1 and FIG. 2. The weakly-acidic aqueous hypochlorous acid solution production unit 112 has an unillustrated water feed pipe through which tap water for dilution is supplied; a first inlet through which aqueous hydrochloric acid solution is injected; a first mixing/diluting unit for mixing aqueous hydrochloric acid solution with the diluting water, based on flow resistance produced therein; a second inlet through which aqueous hypochlorite solution is injected; a second mixing/diluting unit for mixing aqueous hypochlorite solution with the diluting water, based on flow resistance produced therein; and a third mixing/diluting unit for mixing aqueous hydrochloric acid solution diluted in the first mixing/diluting unit with the aqueous hypochlorite solution diluted in the second mixing/diluting unit, based on flow resistance produced therein. By the thus-configured, weakly-acidic aqueous hypochlorous acid solution production unit 112, the thus-produced, weakly-acidic aqueous hypochlorous acid solution is fed through the aqueous hypochlorous acid solution feed pipe (tube) 13 which communicates with the third mixing/diluting unit and extends out therefrom, and through a sterilizing water jetting nozzle 78, described later, into a process tank 31. The weakly-acidic aqueous hypochlorous acid solution production unit 112 adopted in this embodiment was “Salafine (registered trademark)” from Tacmina Corporation.

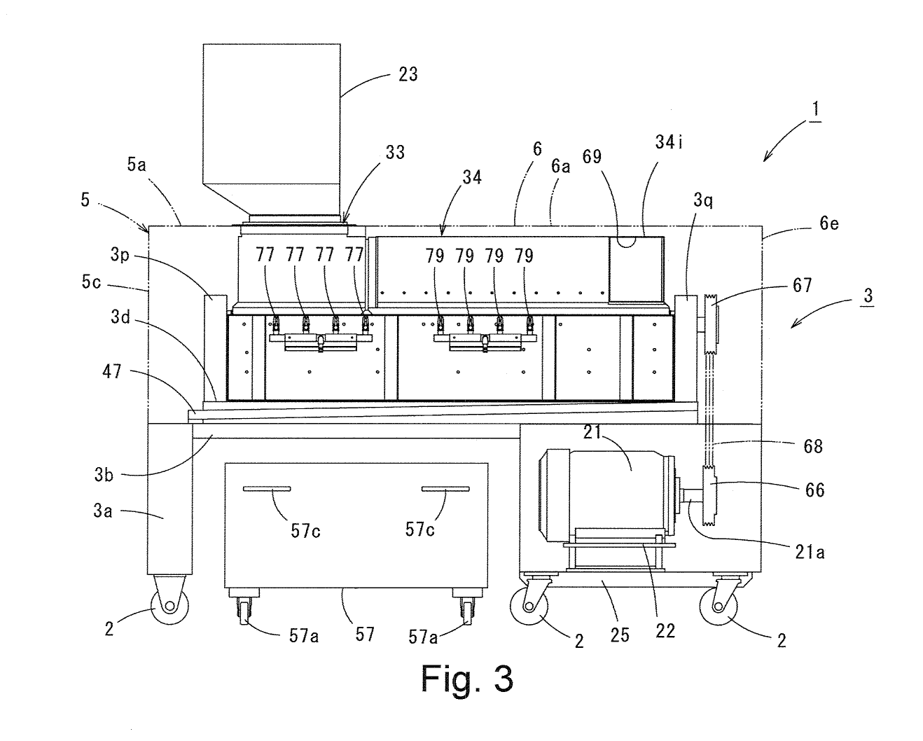

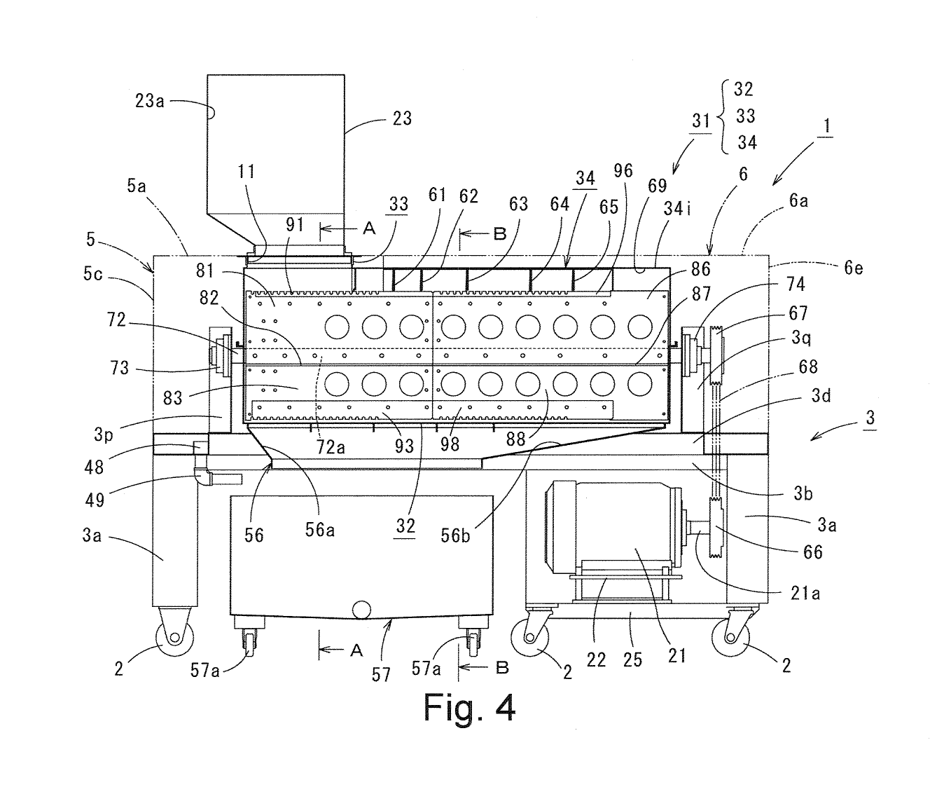

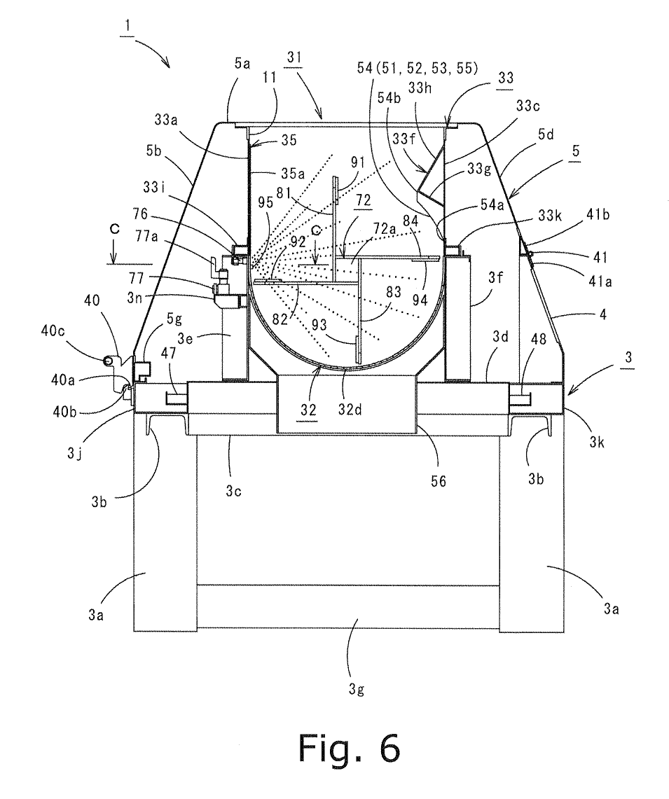

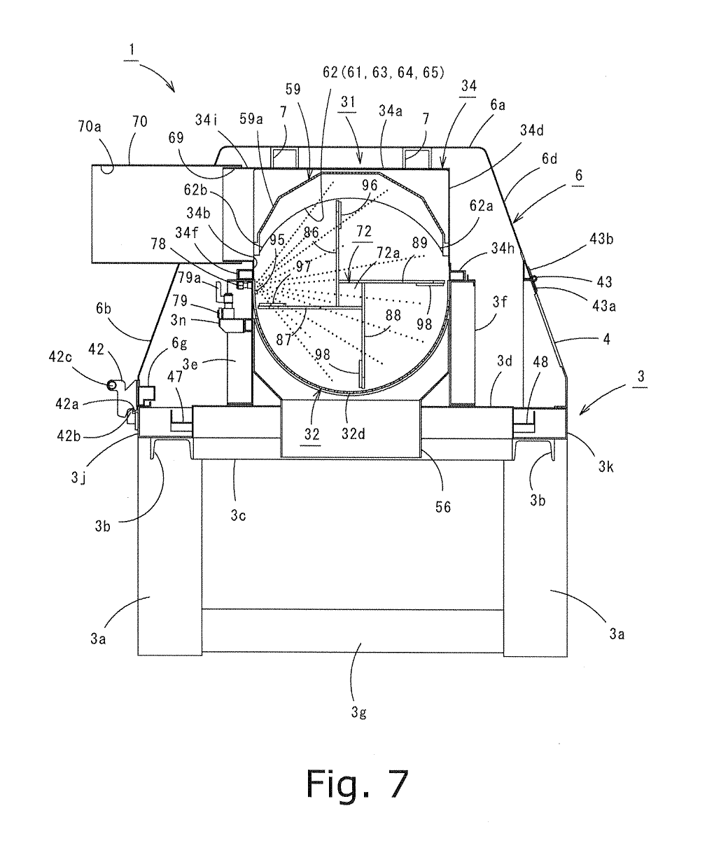

Next, the washing apparatus 1 will be explained. As illustrated in FIG. 2 or FIG. 3, in the washing apparatus 1 of this embodiment, a frame 3 is provided upright in the lower portion thereof, while being supported by six casters 2, the later-described process tank 31 is disposed over the frame 3, and the top portions of which is covered with an upstream-side cover 5 and a downstream-side cover 6. The frame 3 is configured, as illustrated in FIG. 4, FIG. 6 or FIG. 7, by four support columns 3a provided upright respectively at four corners, cross beams 3b, 3b respectively bridged over two front (left in FIG. 6 and FIG. 7) ones and over two rear (right in FIG. 6 and FIG. 7) ones of the support columns 3a; stringer beams 3c orthogonal to the cross beams 3b, 3b and respectively bridged over on the upstream side and on the downstream side; a base frame 3d fixed on the stringer beams 3c on the upstream side and the downstream side so as to bridge them in the lateral direction; a front support 3e and a rear support 3f respectively provided upright on the front side and rear side of the base frame 3d; and bases 3g respectively bridged over two of four support columns 3a on the upstream side and two of the four on the downstream side at the lower ends thereof. On the top end of the frame 3, as illustrated in FIG. 6 or FIG. 7, a process tank body 32 composing the later-described process tank 31 is fixed.

A front outer frame 3j is laid on the front side of base frame 3d of the frame 3, and a rear outer frame 3k is laid on the rear side thereof. To the front surface of the front outer frame 3j, an opposing hook 40b is fixed so as to be engaged with a hook 40a of each of two locking components 40, 40 provided on the upstream side (closer to the feed port 11) as illustrated in FIG. 6, and an opposing hook 42b is fixed so as to be engaged with a hook 42a of each of two locking components 42, 42 on the downstream side (closer to a discharge path 69) as illustrated in FIG. 7. To the top surface at the rear end of the rear outer frame 3k, a bracket 4 is provided upright so as to extend from the upstream side to the downstream side, two hinges 41 on the upstream side (feed port 11 side) are fixed at the upper end of the bracket 4 while respectively directing one wing 41a thereof downward as illustrated in FIG. 6, and two hinges 43 on the downstream side (discharge path 69 side) are fixed at the lower end while respectively directing one wing 43a thereof downward as illustrated in FIG. 7.

The upstream-side cover 5 is formed, as illustrated in FIG. 3 and FIG. 6, into an opened-bottom truncated pyramid box configured by a top plate 5a; and a front side plate 5b, an upstream side plate 5c and a rear side plate 5d which suspend from the top plate 5a while widening the upstream-side cover 5 downward. To the inner surface of the front lower end of the cover 5, a front frame 5g is fixed so that the descent limit thereof may be determined by contact with the top surface of the front outer frame 3j of the frame 3. Opposing side plates 41b of two above-described hinges 41 are respectively fixed to the rear side plate 5d of the cover 5, and two above-described locking components 40 are respectively fixed to the front side plate 5b. Accordingly, the cover 5 may freely open and close while rotating around the hinges 41, and may be locked when closed, by way of hooks 40a of the locking components 40 engaged with the opposing hooks 40b. To the top plate Sa of the cover 5, the top end of the later-described feed frame 33 is fixed in an integrated manner, so that the feed frame 33 may open and close the later-described process tank body 32 by way of the cover 5 which rotates around the hinges 41. Open/close operation of the feed frame 33 may be effected by moving it up and down, by gripping a handle bar 40c (see FIG. 1) which is inserted into through-holes (reference numerals not given) respectively provided to two locking components 40.

The downstream-side cover 6 is formed, as illustrated in FIG. 3 and FIG. 7, into an opened-bottom truncated pyramid box configured by a top plate 6a; and a front side plate 6b, a rear side plate 6d and a downstream side plate 6e which suspend from the top plate 6a while widening the downstream-side cover 6 downward. To the inner surface of the front lower end of the cover 6, a front frame 6g is fixed so that the descent limit thereof may be determined by contact with the top surface of the front outer frame 3j of the frame 3. Opposing wings 43b of two above-described hinges 43 are respectively fixed to the rear side plate 6d of the cover 6, and two above-described locking components 42 are respectively fixed to the front side plate 6b. Accordingly, the cover 6 may freely open and close while rotating around the hinges 43, and may be locked when closed, by way of hooks 42a of the locking components 42 engaged with the opposing hooks 42b. To the top plate 6a of the cover 6, the top end of the later-described rid 34 is fixed in an integrated manner, using unillustrated bolts while placing U-shape beams 7, 7 in between, so that the rid 34 may open and close the later-described process tank body 32 by way of the cover 6 which rotates around the hinges 43. Open/close operation of the rid 34 may be effected by moving it up and down, by gripping a handle bar 42c (see FIG. 1) which is inserted into through-holes (reference numerals not given) respectively provided to two locking components 42.

To the side face of the base frame 3d of the frame 3, a U-shape gutter 47 and a U-shape gutter 48 illustrated in FIG. 6 and FIG. 7 are disposed so as to receive washing water or sterilizing water leaked from the later-described process tank 31 and guide them into an unillustrated waste water treatment unit. The gutter 47 is fixed to the front side of the base frame 3d, while being inclined from the right down to the left in FIG. 3. The opposing gutter 48 is fixed to the rear side of the base frame 3d, while being inclined from the right down to the left, similarly to the gutter 47. The opposing gutter 48 is connected with a drain 49, at the lower portion of the descent end thereof illustrated in FIG. 4. The washing water or sterilizing water leaked out from the later-described process tank 31 may be guided through a pipe element connected to the drain 49, and discharged into the unillustrated waste water treatment unit. Although not illustrated, a drain is also connected to the gutter 47 similarly to the opposing gutter 48, so as to allow discharge therethrough.

An unillustrated control panel for controlling various electronic appliances in connection with the washing apparatus 1 is provided inside the frame 3, and various switches, including an unillustrated start/stop switch for starting or stopping the washing apparatus 1, are provided on the front of the frame 3. Besides them, in the vicinity of two above-described locking components 40 illustrated in FIG. 1 and FIG. 6, an unillustrated limit switch is attached. The limit switch is a detection means for judging whether the cover 5, having a later-described feed frame 33 fixed thereto, is closed or not, electrically connected to the unillustrated control panel, and is configured to prevent a later-described drive motor 21 from operating (rotating) when the feed frame 33 remains open for danger prevention, and to bring the drive motor 21 into emergency stop when the feed frame 33 is opened during operation of the drive motor 21. In the vicinity of two above-described locking components illustrated in FIG. 1 and FIG. 7, an unillustrated limit switch is attached. The limit switch is a detection means for judging whether the cover 6, having a later-described rid 34 fixed thereto, is closed or not, electrically connected to the unillustrated control panel, and is configured to prevent the drive motor 21 from operating (rotating) when the rid 34 remains open for danger prevention, and to bring the drive motor 21 into emergency stop when the rid 34 is opened during operation of the drive motor 21.

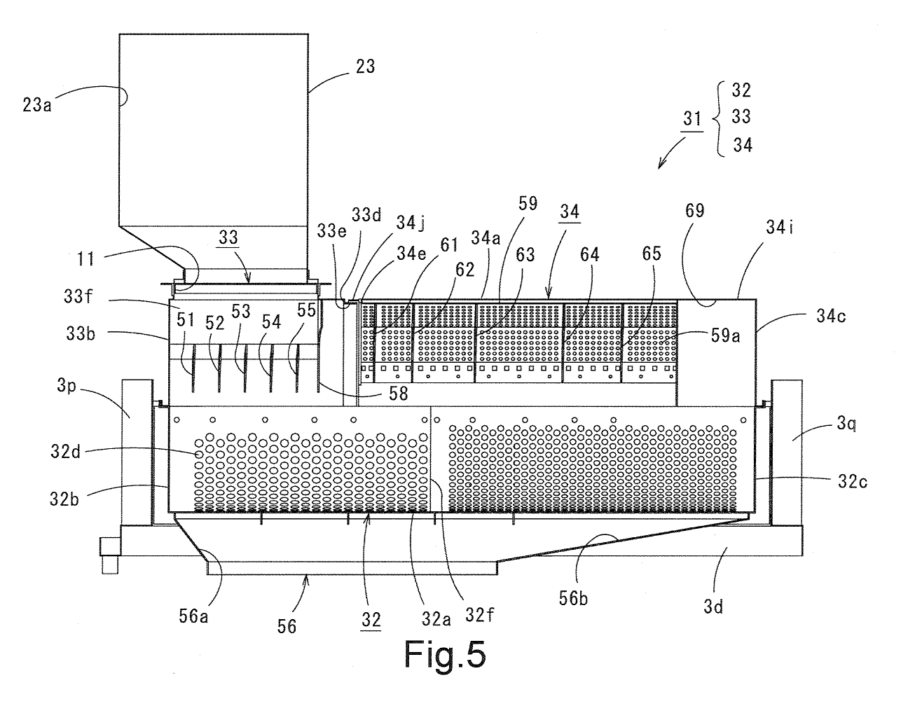

On the frame 3, as illustrated in FIG. 5, the process tank 31 composing the present invention is disposed. The process tank 31 has an opened-top process tank body 32; a feed frame 33 linked in a swingable manner with the opened-top portion (reference numeral not given) of the process tank body 32 while being carried by the cover 5, and having the feed port 11, through which the resin mold is loaded into the process tank 31, formed therein; a rid 34 linked in a swingable manner with the opened-top portion (reference numeral not given) of the process tank body 32 while being carried by the cover 6, in series with the feed frame 33 on the downstream side, and having the discharge path 69 through which the resin mold is discharged out from the process tank 31. The rid 34 closes the process tank body 32 above the downstream portion thereof when closed and brought into contact with the process tank body 32. Overall inner circumferential geometry of the process tank body 32 and the rid 34 are nearly cylindrical, having the longitudinal axis thereof aligned in the horizontal direction (see FIG. 6 and FIG. 7).

Next, the process tank body 32 will be explained. The process tank body 32 has a nearly semicylindrical geometry as illustrated in FIG. 6 and FIG. 7, and is composed of a bottom plate 32a joined at a joint portion 32f (see FIG. 5) which lies in the middle of the longitudinal direction, a left semicircular plate 32b disposed on the left in FIG. 5 (closer to the feed port 11) and formed into nearly semicircular geometry, and a right semicircular plate 32c opposed with the left semicircular plate 32b. The bottom plate 32a, having the nearly semicylindrical geometry and composing the process tank body 32, has a large number of circular openings 32d bored therein to give a staggered pattern, so as to allow therethrough discharge of the adherent (organic wastes and so forth) separated from the resin mold which is cut by later-described first to fourth rotating blades 81 to 84 and fifth to eighth rotating blades 86 to 89 (see FIG. 4, FIG. 6 or FIG. 7). Diameter of the openings 32d of the process tank body 32 is set larger for the upstream left half portion (reference numeral not given) bounded by the joint portion 32f illustrated in FIG. 5, whereas set smaller for the downstream right half portion (reference numeral not given). By setting the different diameters of the openings 32d between the upstream side and downstream side, rate of recovery of the resin mold discharged through the discharge path 69 after being washed and sterilized may be improved. More specifically, the openings 32d of the process tank body 32 are provided only for allowing therethrough discharge of the adherent separated from the resin mold. In the upstream portion of the process tank 31, since the process of washing of the resin mold, fed through the feed port 11, is in the initial stage, where the size of ruptured resin mold and particle size of the adherent still remains relatively large, so that the adherent may not smoothly be discharged if the diameter of the openings 32d is too small. In contrast, in the downstream portion, since the size of ruptured resin mold and the particle size of the adherent are gradually reduced as the articles-to-be-treated moves towards the downstream side, so that not only the adherent but also the resin mold may be discharged through the openings 32d of the process tank body 32 if the diameter of the openings 32d is too large, and thereby the rate of recovery of the resin mold discharged through the discharge path 69 may be degraded.

As illustrated in FIG. 6 and FIG. 7, the thus-configured, near-semicylindrical process tank body 32 is fixed, and thereby supported, at the upper end thereof by the rear surface of the front support 3e of the frame 3 on the front side, and by the front surface of the rear support 3f of the frame 3 on the rear side. Since the resin mold loaded into the process tank 31 moves from the upstream side to the downstream side, while being beaten against the inner circumferential surfaces of the process tank body 32, the feed frame 33 and the rid 34, and while being brought into sliding contact with the individual inner circumferential surfaces, driven by counterclockwise rotation and the resultant centrifugal force of later-described first to fourth rotating blades 81 to 84 and the fifth to eighth rotating blades 86 to 89, so that the adherent separated and washed off from the resin mold is discharged through the large number of openings 32d. The adherent (organic wastes or the like) discharged through the large number of openings 32 is guided to a funnel 56 illustrated in FIG. 4 or FIG. 5, and then stored in a later-described waste reservoir tank 57.

Next, the feed frame 33 will be explained. The feed frame 33 has a front side plate 33a disposed on the left (front side) in FIG. 6, a left side plate 33b (see FIG. 5) continued from the front side plate 33a, a rear side plate 33c (see FIG. 6) continued from the left side plate 33b, and a right side plate 33d (see FIG. 5) continued from the rear side plate 33c and from the front side plate 33a, to thereby give a opened-top, opened-bottom nearly square tubular geometry, wherein the inner space (reference numeral not given) of which is the feed port 11 composing the present invention, through which the resin mold is loaded. On the external of the lower ends of the front side plate 33a and the rear side plate 33c, a front frame 33i and a rear frame 33k, each of which having a square tubular geometry, are respectively formed. The front frame 33i and the rear frame 33k determine the position of descent limit of the feed frame 33, or a state of closure, by contact with the top end surface of the front support 3e and the rear support 3f of the frame 3. On the right of the feed frame 33 as viewed in FIG. 5, a near semicircular engaging flange 33e is formed so as to protrude from the right side plate 33d. The engaging flange 33e is formed to have a diameter nearly same as that of the later-described engaging flange 34j formed on the rid 34, so as to make the both engageable with each other when the feed frame 33 is closed over the process tank body 32, while bringing the outer circumferential surface (reference numeral not given) of the engaging flange 33e and the inner circumferential surface of the engaging flange 34j into contact (see FIG. 5). Accordingly, the feed frame 33 may be opened above the process tank body 32 only after the rid 34 is opened, but may be closed before the rid 34 is closed.

Inside the rear side plate 33c of the feed frame 33, as illustrated in FIG. 5 and FIG. 6, an anti-hop element 33f is disposed so as to obstruct and stop the resin mold tumbled by counterclockwise rotation of the later-described first to fourth rotating blades 81 to 84, in order to prevent the resin mold from hopping up above the feed port 11. The anti-hop element 33f has, as illustrated in FIG. 6, an inclined upper surface 33h fixed to the rear side plate 33c so as to protrude therefrom more largely towards the lower side, and a lower surface 33g continued from the upper surface 33h and inclined towards the lower portion thereof fixed on the rear side plate 33c, and is disposed so as to extend from the left side plate 33b towards the later-described partition plate 58 as illustrated in FIG. 5. The lower surface 33g is provided so as to allow the resin mold to collide thereon, to thereby prevent the resin mold from hopping up above the feed port 11, and is formed so as to be spaced from the outer circumferential surfaces of the later-described first to fourth rotating blades 81 to 84.

Below the anti-hop element 33f, as illustrated in FIG. 6, first to fifth guide ribs 51 to 55 are disposed upright from the inner surface of the rear side plate 33c, so as to guide air in the process tank 31, suck up through the feed port 11 by counterclockwise rotation of the later-described first to fourth rotating blades 81 to 84 and the fifth to eighth rotating blades 86 to 89, from the upstream side towards the down stream side (left to right as viewed in FIG. 5). The first to fifth guide ribs 51 to 55 are inclined while directing front ends 51b to 55b thereof more rightward than rear ends 51a to 55a thereof (inclined from the upstream sides towards the downstream side), and the inner circumferential surfaces of which are formed close to the outer circumferential surfaces of the later-described first to fourth rotating blades 81 to 84 (see FIG. 6). The first to fifth guide ribs 51 to 55 are welded to the inner surface of the rear side plate 33c and the lower surface 33g of the anti-hop element 33f at an angle of inclination of approximately 3°, aiming at achieving an appropriate speed of moving of the resin mold for separation of adherent, washing and sterilization. On the left of the anti-hop element 33f illustrated in FIG. 5, a partition plate 58, having a radius of curvature of the inner circumferential surface thereof same as that of the individual guide ribs 51 to 55, is fixed to the front side plate 33a and to the rear side plate 33c, while being inclined at an approximately same angle.

Inside the front side plate 33a of the feed frame 33, a lining plate 35 is fixed while being brought into contact therewith. The lining plate 35 has a large number of openings 35a bored so as form steps for separating the adherent from the resin mold, against which the resin mold loaded through the feed port 11 is beaten while being driven by the counterclockwise rotation of the first to fourth rotating blades 81 to 84. To the top end of the feed frame 33, the hopper 23 is fixed as illustrated in FIG. 4. The hopper 23 has an opened-top, opened-bottom square tubular geometry, the inside of which is configured as the flow path 23a through which the resin mold is freely allowed to pass from the top to the bottom.

The feed frame 33 is integrally fixed at the top end thereof to the top plate 5a of the cover 5 (see FIG. 6), and the hopper 23 is fixed to the top end (reference numeral not given) of the feed frame 33 (see FIG. 5). Accordingly, the resin mold loaded through the feed port 114 on the conveyor belt 115 illustrated in FIG. 1 is input through the flow path 23a of the hopper 23 and through the feed port 11 of the feed frame 33, into the process tank 31. Open/close operation of the feed frame 33 may be effected by moving it up and down, by gripping the handle bar 40c (see FIG. 1) which is inserted into through-holes (reference numerals not given) respectively provided to two locking components 40 fixed to the cover 5. By the operation, the feed frame 33 may be opened as a result of unlocking of engagement between the hooks 40a and the opposing hooks 40b of two locking components 40 while rotating around the hinges 41, and may be closed as a result of locking of the hooks 40a and the opposing hooks 40b at the bottom, by moving the handle bar 40c downward.

Next, the rid 34 will be explained. The rid 34 is configured, as illustrated in FIG. 5 and FIG. 7, a top plate 34a, a front side plate 34b disposed on the front side, a right side plate 34c continued from the front side plate 34b, a rear side plate 34d continued from the right side plate 34c, and a left side plate 34e continued from the rear side plate 34d and from the front side plate 34b, to thereby give an opened-bottom box geometry. To the lower ends of the front side plate 34b and the rear side plate 34d, a front frame 34f and a rear frame 34h, having square tubular geometry, are respectively formed. The front frame 34f and the rear frame 34h determine the position of descent limit of the rid 34, or state of closure, by contact thereof respectively with the upper end of the front support 3e and the rear support 3f of the frame 3. On the right end of the front side plate 34b of the rid 34 as viewed in FIG. 5, an opening (reference numeral not given) having a width approximately one-seventh of the lateral length of the front side plate 34b is formed. Around the opening, a discharge frame 34i having a square tubular geometry illustrated in FIG. 7 is provided in a protruding manner, while ensuring the inner space of which to serve as the discharge path 69 composing the present invention. To the front of the discharge frame 34i, a discharge duct 70 which is formed into a square tubular geometry, and is extended through the front side plate 6b of the cover 6 while being fixed to the front side plate 6b using unillustrated bolts, is attached. The resin mold separated from the adherent and washed/sterilized in the process tank 31 is then sent through the discharge path 69 and the discharge path 70a of the discharge duct 70, and recovered in an unillustrated recovery box.

On the left of the rid 34 as viewed in FIG. 5, a near semicircular engaging flange 33e is formed so as to protrude from the right side plate 33d. The engaging flange 34j is formed to have a diameter nearly same as that of the engaging flange 33e formed on the feed frame 33, so as to make the both engageable with each other when the feed frame 33 is closed on the front support 3e and the rear support 3f of the frame 3 (see FIG. 7), while bringing the inner circumferential surface (reference numeral not given) of the engaging flange 34j and the outer circumferential surface of the engaging flange 33 into contact. Accordingly, the rid 34 may be opened above the process tank body 32 before the feed frame 33 is opened, but may be closed only after the feed frame 33 is closed.

In the rid 34, as illustrated in FIG. 5 or FIG. 7, a lining plate 59, which has a geometry nearly same as the near-semicylindrical geometry of the bottom plate 32a of the process tank body 32, is fixed so as not to obstruct the discharge frame 34i having the discharge path 69. The lining plate 59 has a large number of openings 59a bored so as form steps for separating the adherent from the resin mold, against which the resin mold loaded through the feed port 11 is beaten while being driven by the counterclockwise rotation of the first to fourth rotating blades 81 to 84, and the fifth to eight rotating blades 86 to 89. Since the resin mold moves while being beaten against the inner circumferential surfaces of the process tank body 32, the feed frame 33 and the rid 34, and while being brought into sliding contact with the individual inner circumferential surfaces, driven by counterclockwise rotation and the resultant centrifugal force of later-described first to fourth rotating blades 81 to 84 and the fifth to eighth rotating blades 86 to 89, so that the adherent separated and washed off from the resin mold is discharged through the large number of openings 32d of the process tank body 32.

On the inner surface of the lining plate 59, as illustrated in FIG. 5 or FIG. 7, sixth to tenth ribs 61 to 65 are disposed upright, so as to guide air in the process tank 31, suck up through the feed port 11 by counterclockwise rotation of the later-described first to fourth rotating blades 81 to 84 and the fifth to eighth rotating blades 86 to 89, from the upstream side towards the down stream side (left to right as viewed in FIG. 5). The sixth to tenth guide ribs 61 to 65 are inclined while directing front ends 61b to 65b thereof more rightward than rear ends 61a to 65a thereof (inclined from the upstream side towards the downstream side), and the inner circumferential surfaces of which are formed close to the outer circumferential surfaces of the later-described first to fourth rotating blades 81 to 84, and the fifth to eighth rotating blades 86 to 89 (see FIG. 7). The sixth to tenth guide ribs 61 to 65 are welded to the inner surface of the lining plate 59 at an angle of inclination of approximately 1°, aiming at achieving an appropriate speed of moving of the resin mold for separation of adherent, washing and sterilization.

The rid 34 is fixed to the top plate 6a of the cover 6, with the aid of opened-bottom, U-sectioned beams 7, 7 using unillustrated bolts (see FIG. 7). To the front portion of the discharge frame 34i of the rid 34, the discharge duct 70 extended through the front side plate 6b of the cover 6 is fixed. Accordingly, the resin mold separated from the adherent, washed, and sterilized in the process tank 31 is then sent through the discharge path 69 in the discharge frame 34i, then through the discharge path 70a of the discharge duct 70, and recovered in an unillustrated recovery box. Open/close operation of the rid 34 may be effected by moving it up and down, by gripping the handle bar 42c (see FIG. 1) which is inserted into through-holes (reference numerals not given) respectively provided to two locking components 42 fixed to the cover 6. By the operation, the rid 34 may be opened as a result of unlocking of engagement between hooks 42 of two locking components 42 and opposing hooks 42b while rotating around the hinges 43, and may be closed as a result of locking of the hooks 42a and the opposing hooks 42b at the bottom, by moving the handle bar 42c downward.

Next, the rotating shaft 72 composing the present invention will be explained. As illustrated in FIG. 4, the rotating shaft 72 is disposed in the thus-configured process tank 31, onto which the later-described first to fourth rotating blades 81 to 84, and the fifth to eighth rotating blades 86 to 89 are respectively fixed to be rotated. The rotating shaft 72 is inserted into the process tank 31, having the longitudinal axis thereof aligned in the horizontal direction, so as to pass almost at the center axis of the near-cylindrical geometry, and so as to extend from an upstream-side bearing frame 3p towards a downstream-side bearing frame 3q which are provided upright on the base frame 3d of the frame 3, where the left end as viewed in FIG. 4 is supported in a freely rotatable manner by one rolling bearing 73 fixed in a freely detachable manner to the bearing frame 3p, and the right end is supported in a freely rotatable manner by another rolling bearing 74 fixed in a freely detachable manner to the bearing frame 3q. As illustrated in FIG. 6 and FIG. 7, the intermediate portion of the rotating shaft 72 between the left and right end portions, is configured by a square portion 72a having a square section, which is formed so as to extend from the feed port 11 side towards the discharge path 69 side (see FIG. 4). On the individual faces of the square portion 72a, the later-described first to fourth rotating blades 81 to 84, and the fifth to eighth rotating blades 86 to 89 are fixed in a stable manner. To the right end of the rotating shaft 72, as illustrated in FIG. 4, a driven-side, V-pulley 67, having V-grooves formed on the outer circumference thereof, is fixed. Three V-belts 68 are stretched between the V-pulley 67 and a drive-side, V-pulley 66 fixed on an output shaft 21a of the later-described drive motor 21, by which the rotating shaft 72 may be rotated counterclockwise as viewed in FIG. 6 and FIG. 7.

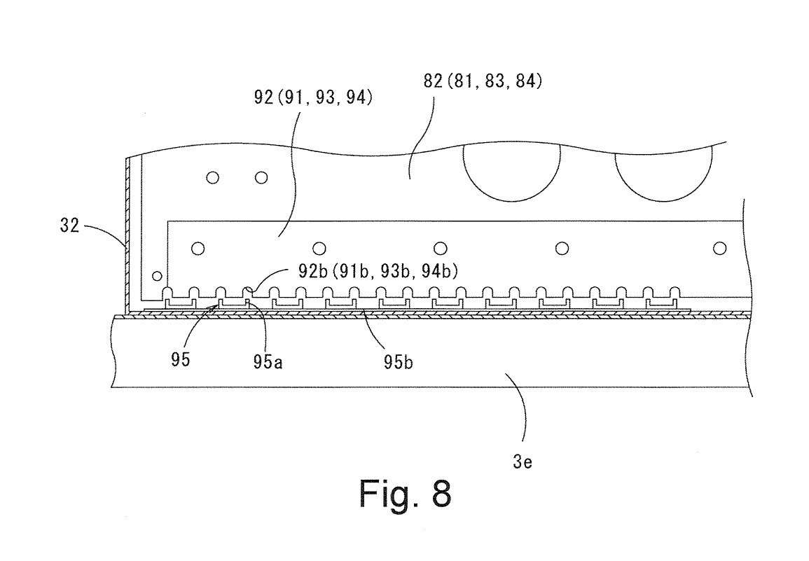

Next, the first to fourth rotating blades 81 to 84, and the fifth to eighth rotating blades 86 to 89, which compose the present invention will be explained. The first to fourth rotating blades 81 to 84, and the fifth to eighth rotating blades 86 to 89 are, as illustrated in FIG. 6 or FIG. 7, fixed on the individual faces of the square portion 72a of the rotating shaft 72 at regular angular intervals of 90° using unillustrated bolts (see FIG. 4). In this embodiment, the individual rotating blades 81 to 84, and the rotating blades 86 to 89 have the same length (width) when measured from the bases thereof on the rotating shaft 72 side towards the ends thereof. The rotating blades 81 to 84 and the rotating blades 86 to 89 have first to fourth comb-like elements 91 to 94 and fifth to eighth comb-like elements 96 to 99, respectively attached to the ends thereof (opposed to the inner circumferential surface of the process tank 31), using bolts (reference numeral not given) in a freely detachable manner. Each of the comb-like elements 91 to 94 and the comb-like elements 96 to 99 has a large number of nearly-U-shaped recesses 91b to 94b and recesses 96b to 99b, respectively, formed at regular intervals along the edge thereof (see FIG. 8). The recesses 91b to 94b, and 96b to 99b configure a comb geometry, together with mesas (reference numeral not given) which rise on both sides thereof.

In the vicinity of the portion where the individual end portions of the comb-like elements 91 to 94, 96 to 99 pass as they rotate, and on the left upper end of the process tank body 32 as viewed in FIG. 6 and FIG. 7, a cutting tool 95 is fixed while placing a patch plate 95b in between. The cutting tool 95 has, as illustrated in FIG. 8, a large number of cutting blades 95a fixed thereon. The cutting blades 95a are formed so as to protrude into the large number of recesses 91b to 94b, 96b to 99b formed respectively on the comb-like elements 91 to 94, 96 to 99. The rotating blade of the present invention is configured by the first to fourth rotating blades 81 to 84, the fifth to eighth rotating blades 86 to 89; and first to fourth comb-like elements 91 to 94 and the fifth to eighth comb-like element 96 to 99 fixed at the ends thereof.

The resin mold loaded through the feed port 11, illustrated in FIG. 4 or FIG. 6, into the process tank 31 collides against the end portions of the first to fourth comb-like elements 91 to 94 and the fifth to eighth comb-like elements 96 to 99 which rotate counterclockwise in the process tank 31, and folded and ruptured into irregular and undefined geometries after being trapped between the individual recesses 91b to 94b, 96b to 99b of the comb-like elements 91 to 94, 96 to 99, and the cutting blades 95a of the cutting tool 95 (see FIG. 8). In the process of such folding and rupturing of the resin mold, the adherent is separated. The irregularly ruptured resin mold moves while being beaten against the inner circumferential surfaces of the process tank body 32, the feed frame 33 and the rid 34, and while being brought into sliding contact with the individual inner circumferential surfaces, driven by counterclockwise rotation and the resultant centrifugal force of the rotating blades 81 to 84, 86 to 89 and the comb-like elements 91 to 94, 96 to 99 illustrated in FIG. 6 or FIG. 7.

Next, four washing water jetting nozzles 76 and four sterilizing water jetting nozzles 78 which configure the present invention will be explained. The washing water jetting nozzles 76 are fixed on the upstream side of the front support 3e of the frame 3 illustrated in FIG. 6 (behind each of four shutoff valves 77 illustrated in FIG. 3, or on the back side of the sheet of drawing), so as to enable jetting of washing water (tap water) through the outlet port into the process tank 31. In the vicinity of the washing water jetting nozzles 76, four shutoff valves 77 (see FIG. 3) are fixed while placing a front frame 3n in between. The secondary side of each of the shutoff valves 77 is connected through an unillustrated pipe component with each washing water jetting nozzle 76, and the primary side is connected through an unillustrated pipe component with a supply means of tap water. By opening an open/close lever 77a respectively provided to each of the shut off valves 77, the tap water may be jetted through the washing water jetting nozzles 76 into the process tank 31, and thereby the resin mold is separated from the adherent adhered thereon. The sterilizing water jetting nozzles 78 are fixed on the downstream side of the front support 3e of the frame 3 illustrated in FIG. 7 (behind each of four shutoff valves 79 illustrated in FIG. 3, or on the back side of the sheet of drawing), so as to enable jetting of sterilizing water (weakly-acidic aqueous hypochlorous acid solution) through the outlet port into the process tank 31. In the vicinity of the sterilizing water jetting nozzles 78, four shutoff valves 79 (see FIG. 3) are fixed while placing a front frame 3n in between. The secondary side of each of the shutoff valves 79 is connected through an unillustrated pipe component with each sterilizing water jetting nozzle 78, and the primary side is connected through an aqueous hypochlorous acid solution feed pipe 13 with a weakly-acidic aqueous hypochlorous acid solution production unit 112 illustrated in FIG. 2. By opening an open/close lever 79a respectively provided to each of the shut off valves 79, the sterilizing water may be jetted through the sterilizing water jetting nozzles 78 into the process tank 31, and thereby the resin mold is washed to remove the adherent adhered thereon, and any destructive fungus adhered thereon is sterilized.

Next, the drive motor 21 composing the present invention will be explained. The drive motor 21 is electrically connected to the control panel and is, as illustrated in FIG. 4, fixed on a mounting base 22 which is disposed on the lower right of the process tank body 32. The mounting base 22 is disposed, so that the vertical position of which is freely adjustable, on a motor frame 25, and the motor frame 25 is fixed to the support column 3a and the cross beam 3b of the frame 3, in the lower right portion of the frame 3. To the output shaft 21a of the drive motor 21, the drive-side, V-pulley 66, having the V-grooves formed on the outer circumference thereof, is fixed. Three V-belts 68 are stretched between the V-pulley 66, and the driven-side, V-pulley 67 fixed to the rotating shaft 72. Rotational drive force of the drive motor 21 may now be transmitted through the V-belts 68 to the rotating shaft 72, and thereby the first to fourth rotating blades 81 to 84, and the fifth to eighth rotating blades 86 to 89 are rotated. Direction or rotation of the drive motor 21 is set so as to rotate the first to fourth rotating blades 81 to 84, and the fifth to eighth rotating blades 86 to 89 counterclockwise as viewed in FIG. 6 and FIG. 7, when the unillustrated start switch is pressed on.

Next, the funnel 56 through which the discharged adherent is guided, and the waste reservoir tank 57 for storing the adherent will be explained. The funnel 56 is formed, as illustrated in FIG. 4 or FIG. 5, to give a funnel geometry composed of a main body 56a and an inclined portion 56b aimed at accepting the adherent (organic wastes or the like) discharged through the openings 32d of the process tank body 32. As illustrated in FIG. 6 or FIG. 7, the upper end (reference numeral not given) of the funnel 56 on the front side is fixed to, and supported by, the front support 3e of the frame 3, and the upper end (reference numeral not given) on the rear side is fixed to, and supported by, the rear support 3f of the frame. The main body 56a of the funnel 56 is formed to give a top-opened and bottom-opened square tubular geometry as illustrated in FIG. 4 or FIG. 5. The inclined portion 56b is connected to the right side portion of the main body 56a, and has an inclined surface (reference numeral not given) which descends from the right upper side thereof, close to the process tank body 32, down to the connection portion on the left lower side, while being opened upward. The waste reservoir tank 57 is formed to give an opened-top, bottomed square cylinder geometry, has four caster 57a therebelow, and has two handles 57c, 57c on the front face thereof as viewed in FIG. 3, for the convenience of pulling the waste reservoir tank 57 out of the washing apparatus 1 from the lower side thereof. Accordingly, the adherent discharged from the openings 32f of the process tank body 32 positioned above the main body 56a of the funnel 56 may be stored directly from the main body 56a into the waste reservoir tank 57, on the other hand, the adherent discharged from the openings 32d above the inclined portion 56b slides on the inclined portion 56b down into the main body 56a, and is then stored in the waste reservoir tank 57.

Next, operations and effects of the thus-configured washing apparatus 1 will be explained referring to the attached drawings.

Upon turning the unillustrated start switch ON, the drive motor 21 illustrated in FIG. 3 starts to operate, and then the fifth to eighth rotating blades 86 to 89 provided in the process tank 31 rotate counterclockwise, together with the rotating shaft 72 connected with the drive motor 21 via the V-pulley 66, the V-belts 68 and the V-pulley 67, the first to fourth rotating blades 81 to 84, as viewed in FIG. 4, FIG. 6 or FIG. 7. By the counterclockwise rotation of the first to fourth rotating blades 81 to 84, air which resides ahead of each of the rotating blades 81 to 84 in the direction of rotation is allowed to flow at a predetermined wind velocity or wind power in the directional range between the centrifugal direction and the direction orthogonal thereto, jetted against the inner circumferential surfaces of the process tank body 32 of the process tank 31, the feed frame 33 and the rid 34, and moves counterclockwise along the inner circumferential surfaces as viewed in FIG. 6 and FIG. 7. On the other hand, by the counterclockwise rotation of the fifth to eighth rotating blades 86 to 89, air which resides ahead of each of the rotating blades 86 to 89 in the direction or rotation is allowed to flow at a predetermined wind velocity or wind power in the directional range between the centrifugal direction and the direction orthogonal thereto, and jetted against the inner circumferential surfaces of the process tank body 32 of the process tank 31, the feed frame 33 and the rid 34, and moves counterclockwise along the inner circumferential surfaces.

In this process, the air in the process tank 31 moves so as to rotate therein while being guided by the first to fifth guide ribs 51 to 55, and the sixth to tenth guide ribs 61 to 65 illustrated in FIG. 5, towards the discharge path 69, and also passes through the openings 32d of the process tank body 32. With the aid of such travel of air, the resin mold moves while being pressed against the inner circumferences of the openings 32d under frictional resistance. Accordingly, in the washing apparatus 1, the adherent separated from the resin mold is discharged through the openings 32d, and the resin mold is discharged through the discharge path 69 illustrated in FIG. 7, and through the discharge path 70a of the discharge duct 70, into the unillustrated recovery box.

In this state, four shutoff valves 77 are opened by operating the respective open/close levers 77a, so as to jet the washing water out from the washing water jetting nozzles 76, and four shutoff valves 79 are opened by operating the respective open/close levers 79a, so as to jet the weakly-acidic aqueous hypochlorous acid solution (sterilizing water) out from the sterilizing water jetting nozzles 78. The resin mold conveyed by the conveyor unit 111 illustrated in FIG. 1, and loaded through the hopper 23 illustrated in FIG. 4, moves through the space in the feed port 11 to the process tank 31 in a sucked manner. By the movement, the resin mold directly collides against the end portions of the first to fourth comb-like elements 91 to 94, and the fifth to eighth comb-like elements 96 to 99, which rotate together with the first to fourth rotating blades 81 to 84, and the fifth to eighth rotating blades 86 to 89; or trapped between the near-U-shaped recesses 91b to 94b, 96b to 99b formed at the end portions of the comb-like elements 91 to 94, 96 to 99, and the individual cutting blades 95a of the cutting tool 95 illustrated in FIG. 8; or moves ahead of the rotating blades 81 to 84, 86 to 89 or the comb-like elements 91 to 94, 96 to 99, in the direction of rotation (in the counterclockwise direction as viewed in FIG. 6 or FIG. 7).

The resin mold directly collided on the end portions of the comb-like elements 91 to 94, 96 to 99 are folded into irregular and undefined geometries, and further ruptured or cut into irregular and undefined geometries. On the other hand, the resin mold trapped between the individual recesses 91b to 94b, 96b to 99b of the comb-like elements 91 to 94, 96 to 99 and the individual cutting blades 95a of the cutting tool 95 may more thoroughly be folded into irregular and undefined geometries, and may more thoroughly be ruptured or cut into irregular and undefined geometries, since the cutting tool 95 is fixed to the process tank body 32 while placing the patch plate 95b illustrated in FIG. 8 in between, whereas the opposing comb-like elements 91 to 94, 96 to 99 are rotated. In the process of such folding or cutting of the resin mold, the adherent is separated from the resin mold while being assisted by impact, and separated and washed off by the washing water jetted through the washing water jetting nozzles 76. The thus-separated adherent is discharged through the openings 32d of the process tank body 32, and the resin mold (partially with the adherent remained thereon) moves towards the downstream side.

The resin mold moved to the downstream side is further beaten against the inner circumferential surfaces of the process tank body 32 of the process tank 31 and the rid 34 illustrated in FIG. 7 (the residual adherent is removed also in this process while being assisted by impact) and moves counterclockwise, by the rotational force, centrifugal force and wind power ascribable to the first to fourth rotating blades 81 to 84 and the first to fourth comb-like elements 91 to 94, and also to the fifth to eighth rotating blade 86 to 89 and the fifth to eighth comb-like elements 96 to 99 disposed on the downstream side thereof, and moves along the inner circumference of the process tank 31 illustrated in FIG. 4 or FIG. 5, to the downstream side, while separating the adherent under friction and sliding contact with the individual inner circumferential surfaces. By the movement, the resin mold may thoroughly be washed to remove the adherent, and may be sterilized by the weakly-acidic aqueous hypochlorous acid solution (sterilizing water) jetted through the sterilizing water jetting nozzles 78 disposed on the downstream side, and then discharged through the discharge path 69 of the rid 34. The adherent may be pressurized against the inner circumferential surface of the process tank body 32, by the air which manages to pass through the large number of openings 32d bored in the process tank body 32, and then discharged through the openings 32d of the process tank body 32.

On the other hand, the resin mold moved ahead of the rotating blades 81 to 84, 86 to 89, or ahead of the comb-like elements 91 to 94, 96 to 99 in the direction of rotation is beaten against the individual inner circumferential surfaces of the process tank body 32 of the process tank 31, the feed frame 33 and the rid 34 illustrated in FIG. 6 or FIG. 7, by the rotational force, centrifugal force and wind power ascribable to the rotating blades 81 to 84, 86 to 89, or the comb-like elements 91 to 94, 96 to 99 (the residual adherent is removed also in this process while being assisted by impact), and moves counterclockwise along the inner circumference surfaces thereof under frictional and slicing contact therewith. In the process of movement of the resin mold, the adherent is separated from the resin mold while being assisted by impact, and the resin mold is washed with the washing water jetted through the washing water jetting nozzles 76. The separated adherent is discharged through the openings 32d of the process tank body 32, and the resin mold (partially with the adherent remained thereon) moves to the down stream side.

The resin mold moved to the downstream side is further beaten against the inner circumferential surfaces of the process tank body 32 of the process tank 31 and the rid 34 illustrated in FIG. 7 (the residual adherent is removed also in this process while being assisted by impact) and moves counterclockwise, by the rotational force, centrifugal force and wind power ascribable to the first to fourth rotating blades 81 to 84 and the first to fourth comb-like elements 91 to 94, and also to the fifth to eighth rotating blade 86 to 89 and the fifth to eighth comb-like elements 96 to 99 disposed on the downstream side thereof, and moves along the inner circumference of the process tank 31, while separating the adherent under friction and sliding contact with the individual inner circumferential surfaces. By the movement, the resin mold may thoroughly be washed to remove the adherent and sterilized by the weakly-acidic aqueous hypochlorous acid solution (sterilizing water) jetted through the sterilizing water jetting nozzles 78 disposed on the downstream side, and then discharged through the discharge path 69 of the rid 34. On the other hand, the adherent may be pressurized against the inner circumferential surface of the process tank body 32, by the air which manages to pass through the large number of openings 32d bored in the process tank body 32, and then discharged through the openings 32d of the process tank body 32.

Accordingly, the resin mold loaded through the hopper 23 illustrated in FIG. 4 is folded in the process tank 31 into irregular and undefined geometries, and may thoroughly be ruptured or cut into irregular and undefined geometries, beaten against the individual inner circumferential surfaces of the process tank body 32 of the process tank 31, the feed frame 33 and the rid 34, moves counterclockwise as viewed in FIG. 6 and FIG. 7, under frictional and slicing contact with the inner circumferential surfaces, moves counterclockwise while being crumpled between the inner circumferential surface of the process tank body 32 and the comb-like elements 91 to 94, 96 to 99, or trapped between the large number of recesses 91b to 94b, 96b to 99b of the comb-like elements 91 to 94, 96 to 99 and the large number of cutting blades 95a of the cutting tool 95r, and then moves towards the downstream side. By repeating the processes, the adherent is separated from the resin mold and discharged through the openings 32d of the process tank body 32, then sent through the funnel 56 illustrated in FIG. 4, and stored in the waste reservoir tank 57. On the other hand, the resin mold may thoroughly be washed to remove the adherent, by the washing water jetted through the upstream-side washing water jetting nozzles 76, and may further thoroughly be washed to remove the adherent and sterilized, by the weakly-acidic aqueous hypochlorous acid solution (sterilizing water) jetted through the downstream-side sterilizing water jetting nozzles 78, and then sent through the discharge path 69 and through the discharge path 70a into the discharge duct 70 illustrated in FIG. 4 or FIG. 7, to be recovered into the unillustrated recovery box.

Since the diameter of the openings 32d of the process tank body 32 is set smaller for the downstream right half (reference numeral not given) as compared with that for the upstream left half (reference numeral not give), while being bounded by the joint portion 32f illustrated in FIG. 5, so that the rate of recovery of the resin mold discharged through the discharge path 69 after being washed and sterilized may be improved. More specifically, the openings 32d of the process tank body 32 are provided only for allowing therethrough discharge of the adherent separated from the resin mold. In the upstream portion of the process tank 31, since the process of separation and washing of the resin mold is still in the initial stage, with the size of ruptured resin mold and particle size of the adherent still remained relatively large, so that the adherent may smoothly be discharged by setting the diameter of the upstream-side openings 32d as large as possible. In contrast, in the downstream portion, since the size of ruptured resin mold and the particle size of the adherent are gradually reduced as the articles-to-be-treated moves towards the downstream side, so that only the adherent may smoothly be discharged through the openings 32d by setting the diameter of the openings 32d smaller than that for the upstream side, and thereby the rate of recovery of the resin mold discharged through the discharge path 69 may be improved.

As described in the above, according to the washing apparatus 1 of the present invention, the resin mold separated from the adherent by the rotation of the rotating blades 81 to 84, 86 to 89, and the comb-like elements 91 to 94, 96 to 99, illustrated in FIG. 4, FIG. 6 or FIG. 7, is further separated from the residual adherent, in the upstream portion of the process tank 31, by the washing water jetted through the washing water jetting nozzles 76 illustrated in FIG. 6 and washed, and still further washed and sterilized in the downstream portion, by the sterilizing water (weakly-acidic aqueous hypochlorous acid solution) jetted through the sterilizing water jetting nozzles 78 illustrated in FIG. 7, so that any destructive fungus contained in the organic wastes or the like, previously adhered on the resin mold before washing, may thoroughly be sterilized, and thereby nasty smell (offensive odor) emitted due to the destructive fungus may be removed. Accordingly, the resin mold discharged through the discharge path 69, illustrated in FIG. 4, FIG. 5 or FIG. 7, of the washing apparatus 1, and recovered therefrom, is no longer causative of nasty smell (offensive odor) even after being recycled in a form of pelletized source material and further made into new products (commodities), and is therefore sufficiently contributive to recycling as the source material for new products.

Since the sterilizing water jetted through the sterilizing water jetting nozzles 78 illustrated in FIG. 7 is the weakly-acidic aqueous hypochlorous acid solution, having a stronger effect of fungus elimination as compared with general chlorine-containing disinfectants or alcohol, so that the sterilizing water may kill destructive fungus adhered on the resin mold, and may thereby remove the nasty smell in a more complete manner. Accordingly, the resin mold discharged through the discharge path 69 of the washing apparatus 1, and recovered therefrom, is no longer causative of nasty smell (offensive odor) even after being recycled in a form of pelletized source material and further made into new products (commodities), and is therefore sufficiently contributive to recycling as the source material for new products.

Inside the feed frame 33 and the rid 34 which compose the upper half of the process tank 31 illustrated in FIG. 5, the first to fifth guide ribs 51 to 55, and the guide ribs 61 to 65, for guiding the resin mold from the upstream side to the downstream side, are respectively provided, wherein the upstream-side guide ribs 51 to 55 are formed to incline at an angle of inclination of approximately 1° from the upstream side towards the downstream side, and the downstream-side guide ribs 61 to 65 are formed to incline at an angle of inclination of approximately 3°. The resin mold may therefore move in the process tank from the upstream side towards the downstream side, at an appropriate velocity which allows thorough separation of the adherent, thorough washing of the resin mold, sterilization of destructive fungus adhered on the resin mold, and removal of nasty smell. Accordingly, the resin mold discharged through the discharge path 69 of the washing apparatus 1, and recovered therefrom, is no longer causative of nasty smell (offensive odor) even after being recycled in a form of pelletized source material and further made into new products (commodities), and is therefore sufficiently contributive to recycling as the source material for new products.

According to the first aspect of the present invention (the invention described in Claim 1), since the washing water jetting nozzles for jetting washing water and the sterilizing water jetting nozzles for jetting sterilizing water are disposed at the upstream side and downstream side, respectively, in the process tank, so that the resin mold input through the feed port into the process tank may be tumbled by a plurality of rotating blades which rotate in the process tank, ruptured into irregular and undefined geometries after colliding against the rotating blades and inner surface of the process tank, and are further washed by washing water jetted through the washing water jetting nozzles so as to be separated from the adherent. The article-to-be-treated is then beaten against the inner circumferential surface of the process tank, while being driven by rotational force and centrifugal force of the rotating blades, and the wrapping material gradually creeps on the inner circumferential surface of the process tank towards the downstream side, while being brought into frictional contact with the inner circumferential surface, so as to be washed and separated from the adherent partially remained thereon, and while being sterilized with the sterilizing water jetted through the sterilizing water jetting nozzles. As a consequence, according to the apparatus for washing resin mold of the first aspect of the present invention, the washed resin mold may successfully be suppressed in nasty smell or offensive odor otherwise possibly ascribable to post-washing proliferation of fungus, may successfully contribute to be recycled as source materials for new products, and may successfully be prevented from being devaluated in the market price.

According to the second aspect of the present invention, since the sterilizing water jetted through the sterilizing water jetting nozzles is a weakly-acidic aqueous hypochlorous acid, having a stronger effect of fungus elimination as compared with general chlorine-containing disinfectants or alcohol, may kill destructive fungus adhered on the wrapping materials or the like, and may thereby remove the nasty smell in a more complete manner. As a consequence, according to the apparatus for washing resin mold of the second aspect of the present invention, the washed resin mold may still more successfully be suppressed in nasty smell or offensive odor otherwise possibly ascribable to post-washing proliferation of fungus, may successfully contribute to be recycled as source materials for new products, and may successfully be prevented from being devaluated in the market price.

Note that the washing apparatus 1 of the present invention is not limited to the above-described embodiment, and may be adoptable typically to the case where the wrapping materials (resin mold) composed of resins are loaded through the feed port 11 together with organic wastes (adherent) enclosed therein, and the wrapping materials are then washed after being separated from the enclosed organic wastes, followed by sterilization and deodorization.

What is claimed is:

1. An apparatus for washing resin mold comprising:
a feed port through which flexible resin mold is loaded;
a process tank laid while horizontally aligning the longitudinal axis thereof, having one end thereof communicated with said feed port, having therein a housing space for housing said resin mold, and having a plurality of openings formed in the bottom surface thereof;
a rotating shaft disposed in said process tank, and rotationally driven by a drive unit;
a plurality of rotating blades having the base ends thereof respectively fixed on said rotating shaft, and the tip ends located inside said process tank;
a discharge path formed at the other end of said process tank, and through which said resin mold after being washed is discharged;
a washing water jetting nozzle for jetting washing water to the upstream side in said process tank; and
a sterilizing water jetting nozzle for jetting sterilizing water to the downstream side in said process tank, relative to the position of said washing water jetting nozzle.

2. The apparatus for washing resin mold as claimed in claim 1, wherein said sterilizing water jetted through said sterilizing water jetting nozzle is a weakly-acidic aqueous hypochlorous acid solution.
